(19) United States
(12) Patent Application Publication
(10) Pub. No.: US 2006/0109660 A1
(43) Pub. Date: May 25, 2006

(54) LIGHT FIXTURE

(76) Inventors: David Wolf, Brooklyn, NY (US); Eugene Diaconu, Bensalem, PA (US)

Correspondence Address: KATTEN MUCHIN ROSENMAN LLP, 575 MADISON AVENUE, NEW YORK, NY, 10022-2585, US

(21) Appl. No.: 10/524,396

(22) PCT Filed: Aug. 14, 2003
(86) PCT No.: PCT/US03/25837

§ 371 Date: Sep. 30, 2005

Related U.S. Application Data
(60) Provisional application No. 60/403,698, filed on Aug. 15, 2002.
(60) Provisional application No. 60/468,206, filed on May 6, 2003.

(51) Int. Cl. F21V 15/00

(52) U.S. Cl. 362/365

(57) ABSTRACT

A light fixture (50, 250, 350) is formed from a plurality of parts that are substantially snap engageable, thereby simplifying assembly and requiring few or no tools. In one embodiment, the fixture (50, 250, 350) is installable from below through a ceiling orifice and supportable by the ceiling alone, without requiring permanent attachment to an existent support beam. In another embodiment, the fixture is provided with hanger supports for attachment to ceiling hangers. The light fixture includes a reflector (70) having an ellipsoidal geometry with improved lighting efficiencies. Also provided is a firebox (500) that houses a light fixture therein.

### CROSS-REFERENCE TO RELATED APPLICATIONS

This application claims the benefit of U.S. Provisional Application 60/403,698 filed Aug. 15, 2002, and U.S. Provisional Application 60/468,206 filed May 6, 2003.

### FIELD OF THE INVENTION

This invention relates to light fixtures in general, and in particular to a down light fixture having a reflector with an ellipsoidal geometry and improved lighting efficiencies and is formed mostly from pieces that are snapped together.

### BACKGROUND OF THE INVENTION

Recessed lighting fixtures can be fairly complicated in both their manufacture and installation. A single lighting fixture is usually formed from several parts that are fixed or semi-permanently connected and presented to a consumer as an installable unit. Furthermore, such lighting fixture is usually not airtight and has an adequate or acceptable lighting efficiency.

In most situations, a consumer purchases a specific lighting fixture to match a specific environment or decor. In addition, the selection of lighting fixtures, particularly when adding to an existing ceiling, is usually limited by the type or adequacy of ceiling support, since certain lighting fixtures require a permanent attachment to a structural support beam of some kind already situated within the ceiling. Furthermore, the ability to vary the appearance of the lighting fixture once installed is usually very difficult, requiring the disassembly or complete removal of the fixture from the ceiling. Thus, there are a variety of limitations a consumer must consider when purchasing a lighting fixture currently on the market.

From a manufacturing perspective, complicated assemblies usually translate into increased costs to the consumer as a result of elaborate machinery and/or increased labor costs. Problems with permanent or semi-permanent connections are difficult to rectify, and lighting fixtures that employ such connections become vulnerable if one integral component breaks down or fails. In addition, lighting fixtures that are installable in a variety of environments must be equipped with the means to achieve such installation, which usually requires an assortment of fasteners and mounting assemblies. Thus, lighting fixtures that require permanent or semi-permanent connections, that are not easily varied in their appearance, and that must be adapted for installation in a variety of environments provide the consumer with a product that is unnecessarily expensive, complicated in construction and aesthetically and functionally limited.

Furthermore, most existing down light fixtures are manufactured with hemispherical or spherical reflector cans that offer adequate lighting efficiencies.

In addition, due to certain municipal requirements or the like, certain light fixtures must be made air right because any holes in the ceilings result in energy loss through the loss of heating and/or cooling escaping through such ceiling openings. Accordingly, it is beneficial to have an airtight light fixture to avoid energy losses normally associated with non-air tight structures.

There is a need, therefore, for a light fixture that is simple and inexpensive to manufacture, easy to install and operate and variable in its presentation, is preferably airtight and has a reflector can with improved lighting efficiencies.

### SUMMARY OF THE INVENTION

A down light fixture is formed from a plurality of parts that are substantially snap or slide engageable. In one embodiment, the fixture is installable from below through a ceiling orifice and supportable by the ceiling alone, without requiring permanent attachment to an existent support beam. In another embodiment, the fixture is provided with hanger supports for attachment to ceiling joist hangers. The light fixture preferably includes an airtight can adapted to receive a lighting unit and a reflector insertable into said can, said reflector having an ellipsoidal geometry with improved lighting efficiencies. Also provided is a firebox that houses said light fixture.

### BRIEF DESCRIPTION OF THE DRAWINGS

FIG. 1 is a perspective view of one embodiment of the light fixture of the present invention.

FIG. 2 is an exploded view thereof.

FIG. 3 is an exploded view of the reflector assembly.

FIG. 4 is an exploded view of the lighting assembly of the invention.

FIG. 5 is an exploded view of the junction box of the present invention.

FIG. 6 is a cross-sectional view of the light fixture of the invention taken through its longitudinal axis.

FIG. 7 is a side elevation of the light fixture of the invention.

FIG. 8 is an elevation view of the light fixture installed in a ceiling.

FIG. 9 illustrates the lighting unit of the invention.

FIG. 10 illustrates the movement of the lighting unit during installation of the fixture.

FIG. 11 is a perspective view of an alternative embodiment of the light fixture of the present invention.

FIG. 12 is an exploded perspective view thereof.

FIG. 13 is an assembled side view thereof shown in cross-section.

FIG. 14 is an exploded perspective view of an alternative embodiment of the light fixture of the present invention.

FIG. 15 is an assembled side view thereof shown in cross-section.

FIG. 16 is a perspective view thereof shown with hanger attachments for installation of the light fixture of the invention.

FIG. 17 is an exploded perspective view of one embodiment of a firebox of the present invention for housing a light fixture of the present invention.

FIG. 18 illustrates a light fixture housed in the firebox of FIG. 17.

FIG. 19 is a perspective view of the firebox thereof shown without the insulation.

FIG. 20. is a perspective view of the firebox of the invention with insulation retainers.

### DETAILED DESCRIPTION

The following detailed description is of the best mode or modes of the invention presently contemplated. Such description is not intended to be understood in a limiting sense, but to be an example of the invention presented solely for illustration thereof, and by reference to which in connection with the following description and the accompanying drawings one skilled in the art may be advised of the advantages and construction of the invention. In the various views of the drawings, like reference characters designate like or similar parts.

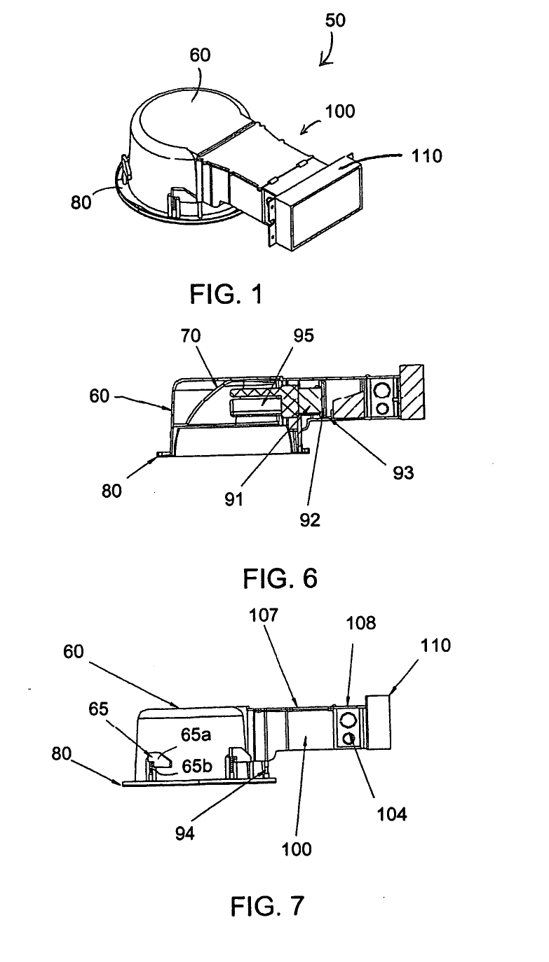

FIGS. 1-10 illustrate a first embodiment of a light fixture 50 of the present invention, which generally comprises a can 60, a reflector 70, a ceiling plate 80 that serves as a decorative trim member, a lighting unit 90 (FIGS. 9-10) and a junction box 100. The light fixture 50 is preferably airtight, so it can be installed in a variety of locations, and it is mostly assembled using slidable and/or snap-fit connections. The fixture is particularly suited for both new construction and as a retrofit for existing installations.

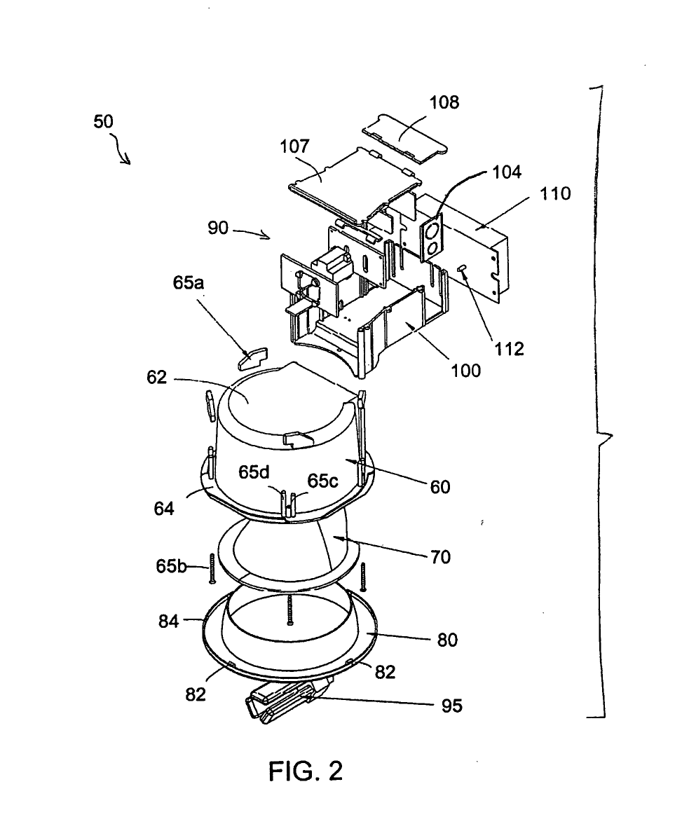

The junction box 100 houses the lighting unit 90 (FIGS. 4 and 5) and is attached to a ballast 110 at the rear thereof and to the can 60 at the front thereof. The ballast 110 attaches to the junction box 100 via the slidable engagement of pins 112 (FIG. 2) on the ballast 110 with slots (FIGS. 4 and 5) at the rear of the junction box 100. The junction box 100 is provided with removable panels 104 to accommodate wiring and the like, each panel 104 being provided with removable cutouts 105 for wiring access. The junction box 100 is also provided with a junction box cover 107 and a wiring compartment cover 108, which are each capable of snapping onto the junction box 100.

The ballast 110 being both part of and mounted outside of the junction box 100 is unique in the industry for new work installations. The ballast is usually outside of the function box so it runs cooler and therefore more efficiently. However, because the ballast 110 of the invention is outside of the junction box 100 (yet slidably attached thereto), versus standard installations where it is attached to a framing kit (not shown), servicing the fixture 50 of the present invention is easily performed by removing entire fixture 50 from the ceiling without first having to remove the ballast 110 inside the ceiling to service the unit. This capability eliminates the need for a framing kit, unless it is specified by contractor.

The interlock between the can 60 and the junction box 100 allows such parts to slide together easily to become a single unit. This is unique in the industry and provides two options to install the fixture 50, either in new or retrofit installations. It is possible to pre-install the fixture 50 before the ceiling is constructed or after the ceiling is in place. For example, when the lighting inspector inspects wiring he doesn't have to pull out entire ceiling and can inspect fixture splices in highly accessible manner. It also simplifies the servicing and cleaning process.

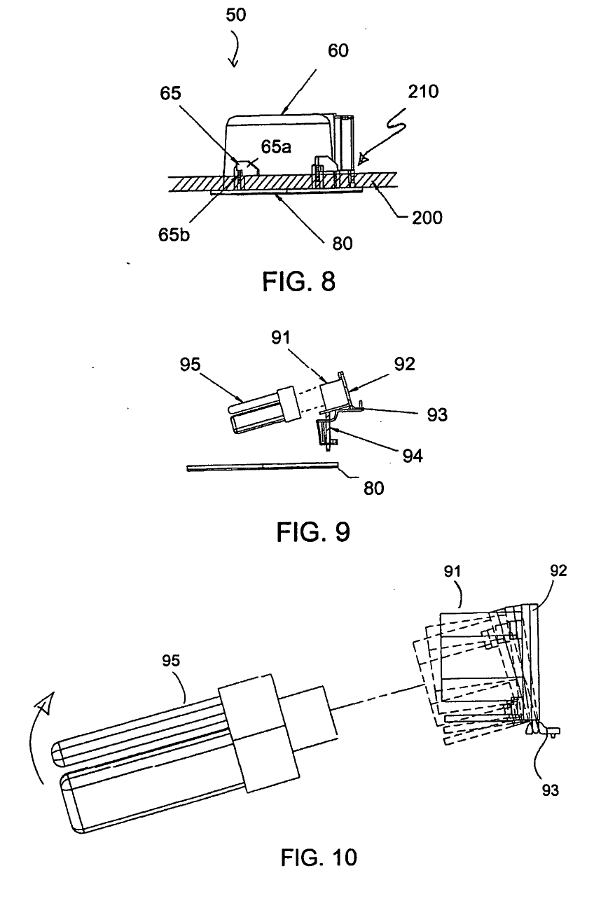

The lighting unit 90 (FIGS. 9 and 10), which comprises a lighting socket 91 and socket holder 92, is slidably engaged with the interior sidewalls 106 of the junction box 100 (FIG. 5). The socket holder 92 is comprised of two parts (see FIG. 4) that sandwich the socket 91 and snap together, eliminating the need to screw in the socket 91, which is currently standard industry operating procedure. A socket hinge 93 and junction box pin 94 are attached to the lighting socket 91 for pivoting of the lighting socket 91 within the junction box 100. Specifically, the socket holder 92 is initially angled downward under the influence of gravity for easy insertion of a lamp element 95 therein and for changing of lamps thereafter (re-lamping), particularly when the lighting socket 91 is already installed in a ceiling 200 (FIG. 8). This functional design is unique to the industry. Subsequent to insertion of the lamp element 95, attachment of the ceiling plate 80 to the can 60 as described below causes the ceiling plate 80 to push against the junction box pin 94, which causes the socket holder 92 to rotate about the socket hinge 93 and thereby reorient the lighting socket 91 and lamp element 95 into a substantially horizontal position (FIG. 6). Thus, as the reflector 70, which has an ellipsoidal geometry, is shaped in a fairly close relation to the lamp unit 95 (FIG. 6), which results in the lighting unit 90 producing an overall efficiency of greater than approximately 84%, it is beneficial that the socket holder 92 is capable of pivoting away from the reflector 70 for easy manipulation of the lamp unit 95 relative to the reflector 70 and the socket 91. This eliminates the need to have holes in the fixture 50 for the insertion and removal of lamp elements 95. Accordingly, pin-based CFL (compact fluorescent lamps) lamps, which have to be snapped into sockets, can now be snugly fitted without error, which is particularly important with horizontally-positioned lamps where servicing and removal are difficult.

The can 60 has a first closed end 62 positionable in a ceiling 200 and a second free end terminating in a flange 64 (FIG. 2). The flange 64 is preferably circumferentially dimensioned so that it will not pass through a ceiling orifice 210 (FIG. 8) through which the light fixture 50 is installed. At least one retaining member 65, and preferably a plurality of retaining members 65 for retaining the can 60 in a ceiling location 200 are disposed on the can 60 and preferably around the flange 64 as shown in FIGS. 1-3 and 7-8. The can 60 is inserted from its first end 62 through a ceiling orifice 210 from below the ceiling 200 until the rear surface of the flange 64 abuts the exposed surface of the ceiling 200.

Prior to or after insertion of the can 60 through a ceiling orifice 210, the reflector 70 is snapped into the can 60. Due to its ellipsoidal geometry, which creates the form factor of the reflector 70 and achieves superior light output efficiencies, the reflector 70 is uniquely designed to maximize the light output and efficiency. Such ellipsoidal geometry is preferably achieved using injection molded technology. Current tests reveal a lighting efficiency of approximately 84%.

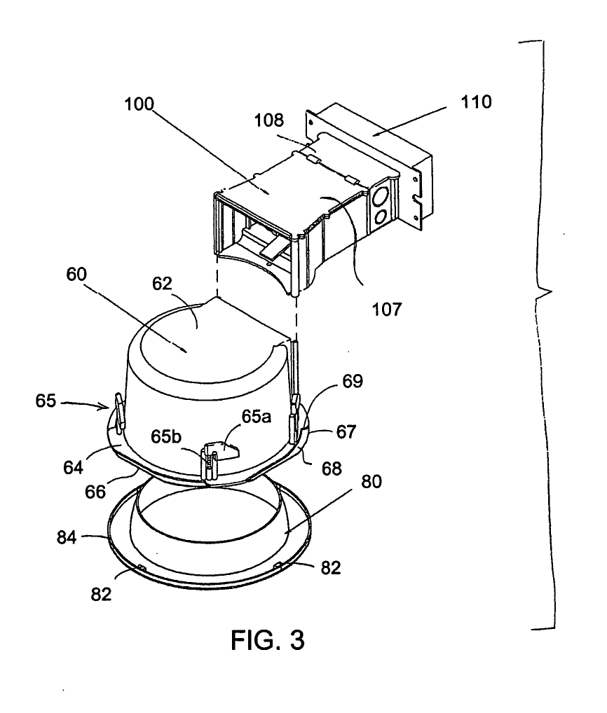

As shown in FIGS. 2 and 3, the ceiling plate 80 is provided with at least one tab 82, and more preferably, a plurality of tabs 82 extending inwardly from a peripheral rim 84. Due to the thinness of the can flange 64, the clearance between the tabs 82 and rear surface of the ceiling plate 80 is relatively small. The peripheral edge of the can flange 64 has a series of arcuate sections 67 and planar sections 66, with the front surface of the flange 64 being entirely planar. The rear surface of the flange 64 is formed with ramped portions 68 with the thickness of the flange 64 varying from approximately 2 mm to approximately 1 mm along such ramped portions 68.

Initially, the ceiling plate 80 is brought into overlapping alignment with the can flange 64 so that the ceiling plate tabs 82 are situated adjacent to the planar sections 66 of the can flange 64 and not securely fastened to the flange 64. Then, the ceiling plate 80 is rotated clockwise, so that the tabs 82 slide onto the ramped portions 68 along the rear surface of the can flange 64 until the tabs 82 encounter stops 69 (FIG. 3) formed by the ends of the ramped portions 68, and thus becomes securely fitted to the can flange 64. Removal of the ceiling plate 80 from the can flange 64 is accomplished by a counter-clockwise rotation of the ceiling plate 80 with respect to the can flange 64.

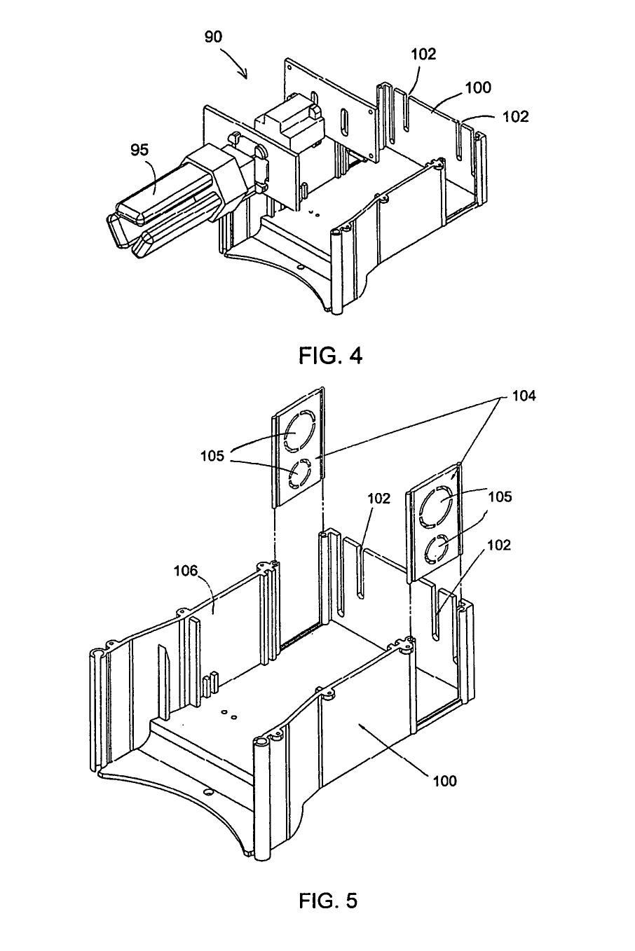

FIGS. 1-3 and 7-8 illustrate the retaining members 65 used to fasten the can 60 to the ceiling 200. The primary component of a retaining member 65 is a movable flag-like member (flag) 65a threaded on a threaded fastener 65b, which threaded fastener 65b has been passed through the can flange 64. The flag 65a is positioned between a short post 65c and a tall post 65d (FIG. 2). Initially, the flag 65a is positioned directly over the short post 65c as shown in FIGS. 3 and 7 and lies adjacent the can 60. Initially, the flag 65a is also positioned such that it does not extend beyond the peripheral edge of the can flange 64. There is a tight engagement between the flag 65a and fastener 65b so that the flag 65a turns with the fastener 65b when the flag 65a is not abutting one of the posts 65c,d or the can 60. Counter-clockwise (fastening) rotation of the threaded fastener 65b via the flange 64 causes the flag 65a to rotate counter-clockwise with the fastener 65b until the flag 65a abuts the larger post 65d and extends beyond the periphery of the can flange 64. Continued rotation of the threaded fastener 65b while abutting the larger post 65d causes the flag 65a to thread or move downwardly along the fastener 65b and the larger post 65d until the flag 65a engages the ceiling 200. Clockwise rotation of the fastener 65b causes the flag 65a to rotate with the fastener 65b clockwise until such flag 65a abuts the shorter post 65c. Continued clockwise rotation of the threaded fastener 65b causes the post-abutting flag 65a to thread or move upwardly until the flag 65b clears the shorter post 65c, at which point the flag 65a continues a clockwise rotation with the fastener 65b until the flag 65a clears the periphery of the can flange 64 and lies adjacent the can 60 as shown in FIGS. 3, 7 and 8.

The light fixture design enables the fixture 50 to be installed in one of two ways. The first is the “new construction” method, whereby the junction box 100 is wired up before the ceiling 200 itself is installed. Subsequently, the can 60 is attached to the junction box 100 by simply sliding the two pieces 60, 100 together (FIG. 3). The second or “retro-fit” method is done after the ceiling 200 is installed, and the fixture 50 is inserted in one piece.

The light fixture 50 is initially assembled to the extent shown in FIG. 1, but without attachment of the lamp unit 95 or the ceiling plate 80. Such partially assembled light fixture 50 is then inserted through an orifice 210 in the ceiling 200 until the can flange 64, and more particularly the rear surface thereof, abuts the exposed surface of the ceiling 200. The can flange 64 is dimensioned to prevent complete or over insertion of the light fixture 50 through the ceiling orifice 210. Once the flange 64 has been positioned against the exposed surface of the ceiling 200, the threaded fasteners 64b are tightened until the flags 65a abut posts 65d, thereby extending beyond the periphery of the ceiling orifice 210, and continued tightening of the fasteners 65b causes the flags 65a to move downward until such flags 65a clamp the unexposed surface of the ceiling 200 as shown in FIG. 8, thereby securing the can 60 and the junction box 100 to the ceiling 200. Once the can 60 and junction box 100 have been secured to the ceiling 200, a lamp unit 95 is inserted into the downwardly-angled socket 91 (FIG. 9), after which the ceiling plate 80 is rotatably and securely engaged with the can flange 64 through the movement of tabs 82 along ramped portions 68 as previously described. Attachment of the ceiling plate 80 to the can flange 64 causes the ceiling plate 80 to impact against the junction box pin 94 (FIG. 9), which causes the socket 91 and lamp unit 95 to rotate into a position shown in FIG. 6. Later removal of the ceiling plate 80 from the secured light fixture 50 is as easy as rotating the ceiling plate 80 in the opposite direction so that tabs 82 become aligned with the planar portions 66 of the can flange 64. Later withdrawal of the fixture 50 from the ceiling 200 through a ceiling orifice 210 is also as easy as rotating the threaded fasteners 65b until each flag 65a lies adjacent to the can 64 and no longer extends beyond the periphery of the ceiling orifice 210.

It should be appreciated that the light fixture 50 of the present invention is secured directly to the ceiling 200 via retaining members 65a, and does not require attachment to a support beam or the like, which support beam may or may not be present in a desired lighting location. It should also be appreciated that the thinness of the flange 64 and the relative thinness of the ceiling plate tabs 82 and peripheral edge 84 of the ceiling plate 80 allows the ceiling plate 80 to securely engage the flange 64 and lie flush against the exposed ceiling surface 200 after engagement.

It should also be appreciated that most of the components that form the lighting fixture 50 are snap engageable or slidably engageable. In fact, it is only during the rotation of the retaining members 65b in the embodiment described above that an external tool is required. The ease with which the entire lighting fixture snaps together also allows for variations in the aesthetic (viewable) components, such as the ceiling plate 80 and any other components visible from below the ceiling 200.

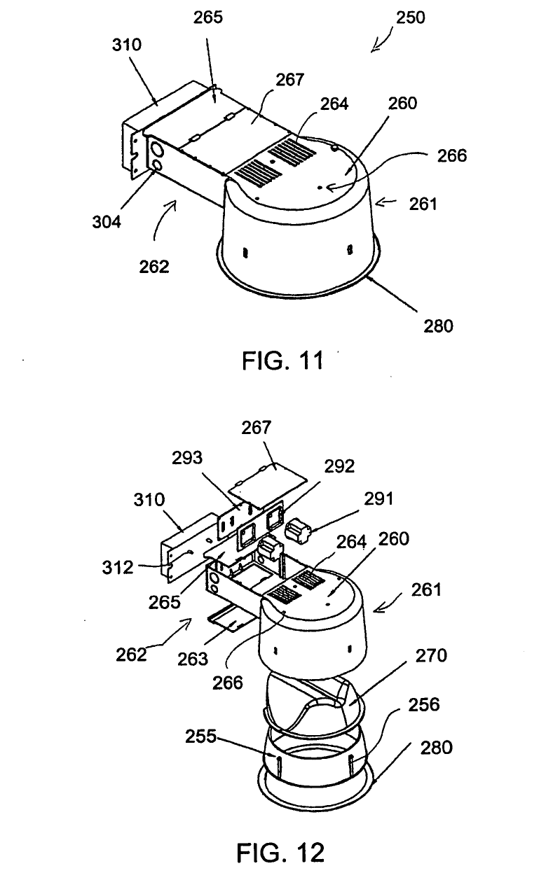

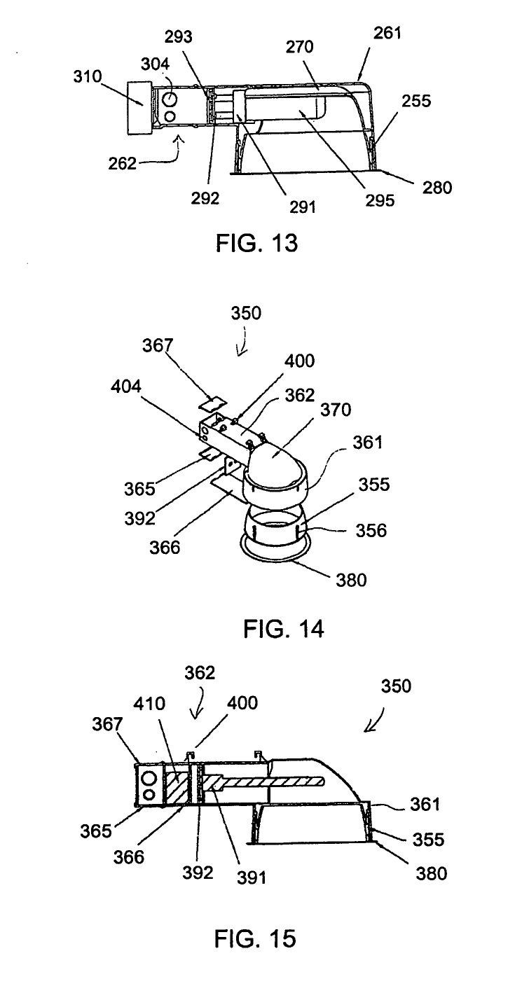

FIGS. 11-13 illustrate an alternative embodiment of a light fixture 250 of the present invention, wherein the can 261 and junction box 262 are molded as a single unit 260 and are preferably formed from polycarbonate, although other materials may be used. The junction box 262 is attached to a ballast 310 at the rear thereof via the slidable engagement of the ballast pins 312 (FIG. 12) with slots (not shown) provided at the rear of the junction box 310 in the same manner as discussed in connection with the engagement of the ballast 110 and junction box 100 of FIGS. 1-10. A self-ventilating “louvered” system (vents 264) is provided above the lamp unit 295 and socket 291 to release heat and prevent heat build-up, thereby improving light output efficiency. The lamp socket 291 is secured between the socket holder 292 plate and a back plate 293, which clip together. The combined can/junction box 260 has knockouts 304 molded into both sides of the junction box 262 for electrical connections. A baffle 255 clips into the can 261 using cantilever clips 256, making it removable. The ceiling ring 280 has a low profile and clips into the baffle 255. This snap-in ceiling ring 280 insures simpler removal from the ceiling. A reflector 270 is secured to the can 261 by screws (not shown), which is an industry safety advancement, because it enables safe cleaning of the reflector 270 without the possibility of electric shock. Ellipsoidal geometry (see FIG. 12) is used to create the form factor of the reflector 270, achieving superior light output efficiencies on the order of approximately 84%. The junction box 262 also has hinged lids 263, 265, 267 for ease of wiring, whereas top lid 267 is provided for access to the lighting socket 291. The can 261 also has a plurality of holes 266 (four holes being shown for purposes of illustration) on top for fastening a framing kit (not shown) thereto.

The light fixture 250 of FIGS. 11-13 is installed as a single unit through a ceiling orifice and is attached to a ceiling through the use of retaining members as described in connection with FIGS. 1-10 or through the use of a framing kit attachable to the can 261 via holes 266. A critical feature of the light fixture 250 of this embodiment is the ellipsoidal geometry of the reflector 270, which produces light output efficiencies that are superior to spherical-type reflectors. As with the first described embodiment of FIGS. 1-10, mostly all of the components of the light fixture 250 snap or slide together or are engageable together without the use of tools or the like.

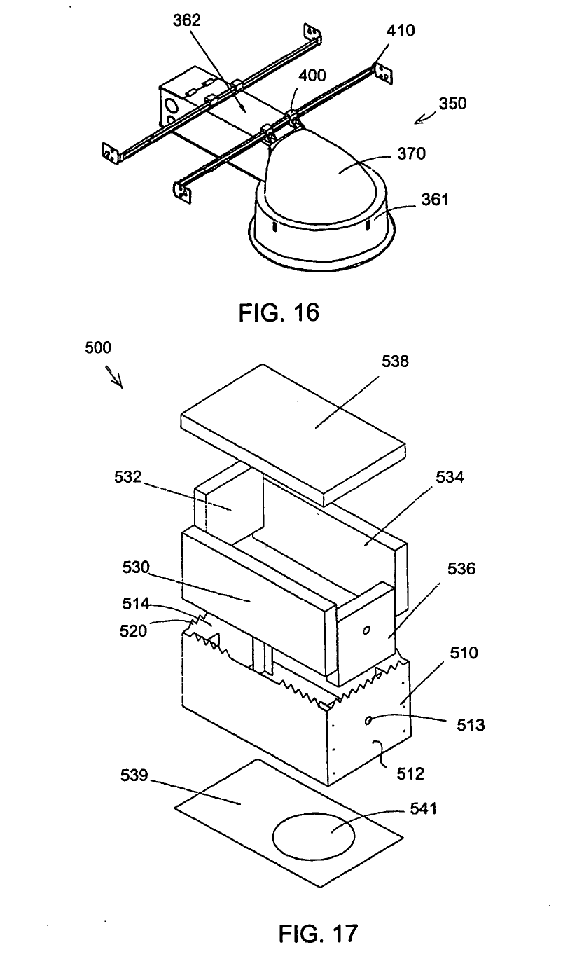

FIGS. 14-16 illustrate yet another embodiment of a light fixture 350 of the present invention, wherein the reflector 370 and junction box 362 are molded as a single unit 360 and preferably formed from polycarbonate, although other materials may be used. The embodiment of FIGS. 14-16 is smaller than the embodiment of FIGS. 11-13, such that, for example, the embodiment of FIGS. 11-13 might illustrate an eight-inch can 261, while the embodiment of FIGS. 14-16 might illustrate a six- or seven-inch can 361. The reflector 370 is part of the can 361 instead of a separate part that is fastened inside. Ellipsoidal geometry, is used to create the form factor of the reflector 370, achieving superior light output efficiencies. The junction box 362 is also a part of the can 361, such that the can 361, junction box 362 and reflector 370 are a single unit. A fluorescent lamp socket 391 clips into a polycarbonate (or other material) socket bracket 392, which slides into the junction box 362 and is held in place by ribs (not shown). The junction box 362 has knockouts 404 molded into both sides for electrical connections, and lids 365-367 for easy access to the inside of the junction box 362. A baffle 355 clips into the can 361 using cantilever clips 356, making it removable. The ceiling ring 380 has a low profile and clips into the baffle 355 and insures simpler removal from the ceiling. Hanger bar supports 400 are molded into the junction box 362 and are provided instead of a separate framing kit. Steel hanger bars 410 slide in through the supports 400 and are secured using set screws to ceiling joists (not shown).

The light fixture 350 of FIGS. 14-16 is preferably installed using the hanger bars 410 and hanger bar supports 400 as part of a new construction. A critical feature of the light fixture 350 of this embodiment is the ellipsoidal geometry of the reflector 370, which produces light output efficiencies that are superior to spherical-type reflectors. As with the first two described embodiment of FIGS. 1-13, mostly all of the components of the light fixture 350 snap or slide together or are engageable together without the use of tools or the like.

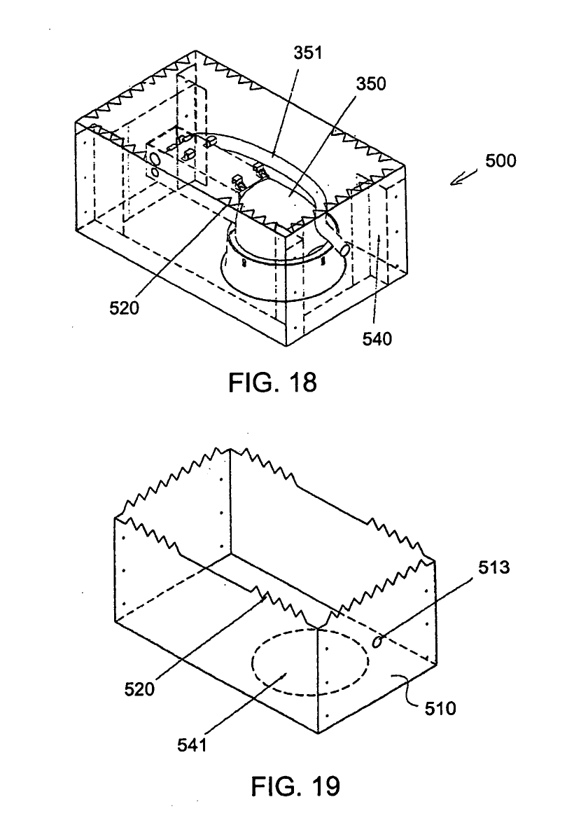

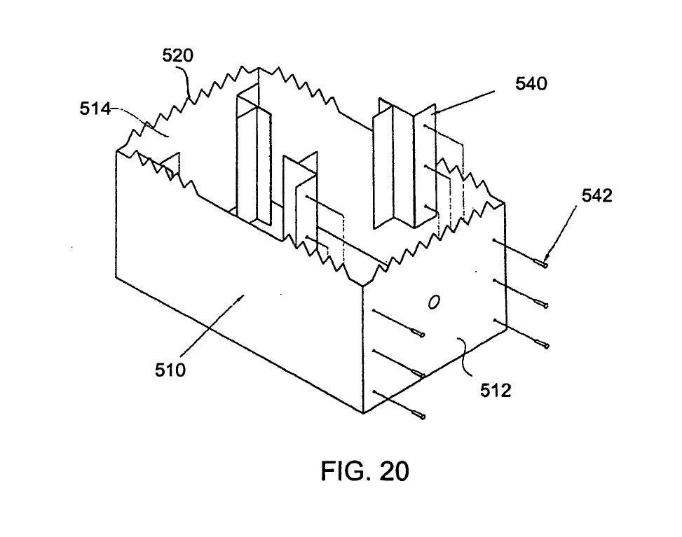

FIGS. 17-20 illustrate a firebox 500 of the present invention that is used to house a light fixture therein. Such firebox 500 may be installed in a ceiling prior to installation of a light fixture therein, or the firebox 500 and a light fixture may be installed as a combined, single unit. For purposes of explanation, the light fixture 350 of the embodiment of FIGS. 14-16 will be used to illustrate a light fixture contained within the firebox 500.

The firebox 510 is preferably fabricated from twenty-four gauge (0.024 in) galvanized sheet metal and provided with triangular protrusions 520 extending from the top of each sidewall to secure insulation when bent ninety degrees inward. One and one-half inch thick mineral wool insulation is provided on all sides 530, 532, 534, 536 and top 538, and held in place by four galvanized sheet metal retainers 540 riveted (via rivets 542) to the firebox front and back walls 512, 514. Since the top of the firebox 510 is open, the upper piece of insulation 538 provides the only upper insulative barrier for a light fixture housed therein. A quarter-inch compressed fiberglass pad 539 on the bottom of the firebox 500 acts as an insulator against the ceiling sheet rock (not shown), and is preferably provided with a hole 541 for accommodating the can or baffle of the light fixture housed within. A light fixture 350 is secured inside the firebox 510 and has a flexible wire housing 351 that connects through a wiring hole 513 in the front 512 of the metal firebox 510 where external wires are connected. Of course, while certain dimensions and materials are discussed herein, it will be understood that other materials and dimensions could be used as desired.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

We claim:

1. A light fixture for installation in a ceiling comprising:
a can positioned adjacent a junction box, said can having a first end substantially positionable in said ceiling and a second end having a flange adjacently positionable against an exposed surface of the ceiling about an orifice in said ceiling through which said can extends,
a lighting unit removably engageable with said junction box,
a retaining means for retaining said can in said ceiling,
a ceiling plate member rotatingly, removably and securely engageable with said flange to provide an exterior trim to the light fixture, and
a reflector having an ellipsoidal geometry that is removably engageable with said can and capable of producing a lighting efficiency of at least 84%.

2. A light fixture in accordance with claim 1, wherein said lighting unit pivots from a first, angled position relative to said junction box for loading of a lighting element into said lighting unit, to a second, substantially horizontal position during illumination of said lighting element and normal use of said light fixture.

3. A light fixture in accordance with claim 2, wherein said lighting unit pivots from said first position to said second position in response to the attachment of said ceiling plate to said flange.

4. A light fixture in accordance with claim 2, wherein said lighting unit falls to said first position under gravity when said ceiling plate is removed from said flange.

5. A light fixture in accordance with claim 2, wherein said lighting unit further comprises a socket attached to a socket holder, a socket hinge attached to said socket holder and removably attachable to said junction box, and a pin attached to said socket holder for controlling the positioning of said lighting unit.

6. A light fixture in accordance with claim 5, wherein said pin extends below said flange prior to assembly of said ceiling plate on said flange.

7. A light fixture in accordance with claim 6, wherein said ceiling plate contacts said pin during attachment of said ceiling plate with said flange and causes said lighting unit to pivot from said first position to said second position.

8. A light fixture in accordance with claim 1, wherein said retaining means further comprise retaining members disposed on said can for retaining said can in said ceiling, said retaining members being accessible through said can from the exposed surface of said ceiling.

9. A light fixture in accordance with claim 8, wherein said retaining members are movable from an insertion position lying adjacent said can for installation and insertion of said can through said orifice, to a support position extending outwardly from said can to prevent said can from falling through said orifice.

10. A light fixture in accordance with claim 8, wherein said retaining members are adapted for clamping engagement against said unexposed surface of the ceiling in said support position.

11. A light fixture in accordance with claim 8, wherein said lighting fixture is supported by said retaining members solely by the clamping engagement of said retaining members against an unexposed surface of said ceiling.

12. A light fixture in accordance with claim 8, wherein said retaining members are disposed on said flange.

13. A light fixture in accordance with claim 1, wherein said retaining means further comprises hanger supports integrally formed into said junction box for receiving and supporting hanger bars for attachment of said light fixture to a ceiling.

14. A light fixture in accordance with claim 1, wherein said can is airtight.

15. A light fixture in accordance with claim 1, wherein said can further comprises a vent for dissipating excess heat from said can.

16. A light fixture in accordance with claim 1, wherein said reflector is integrally formed with said junction box.

17. A light fixture in accordance with claim 1, further comprising a ballast slidably attachable to said junction box.

18. A light fixture in accordance with claim 1, further comprising a ballast housed within said junction box.

19. A firebox for containing a light fixture comprising:
a plurality of sidewalls, a bottom and an open top,
a plurality of insulation retainers secured to said firebox and forming a plurality of insulation chambers,
a plurality of side insulation sections slidably inserted into said chambers,
a top insulation section extending across said open top and secured to said firebox via a plurality of bendable protrusions provided on said four side walls, and
a bottom insulation section extending across said bottom.

20. A firebox in accordance with claim 19, further comprising a light fixture orifice provided in said bottom insulation section for extension of a light fixture can therethrough.

21. A firebox in accordance with claim 19, wherein said insulation is mineral wool insulation and said plurality of side walls are formed from sheet metal.

22. A firebox in accordance with claim 19, further comprising a first wiring orifice provided in one of said side walls and a second wiring orifice provided in said side insulation section that is positioned adjacent said one of said side walls provided with said first wiring orifice.
